(19) United States
(12) Patent Application Publication
(10) Pub. No.: US 2019/0366977 A1
(43) Pub. Date: Dec. 5, 2019

(54) Disk Intelligent Rechargeable Locking Device for Wheels Based on Cloud Wireless Control

(71) Applicant: Yuk Fong LAI, Hong Kong (HK)

(72) Inventor: Yuk Fong LAI, Hong Kong (HK)

(21) Appl. No.: 16/055,176

(22) Filed: Aug. 6, 2018

(30) Foreign Application Priority Data
May 31, 2018 (CN) 201810546817.7

(51) Int. Cl. B60R 25/09; B60R 25/00; E05B 79/16

(52) U.S. Cl. CPC B60R 25/09; B60R 2325/106; E05B 79/16; B60R 25/002

(57) ABSTRACT

The invention relates to a disk intelligent rechargeable locking device for wheels based on cloud wireless control which includes a first element, a second element, a connecting rod and a connecting sleeve. The first element includes a first housing, an end cap, a motor, a sleeve, a rotatory encoder, a latch, a first battery and a microcontroller. The second element includes an inner sleeve and an outer sleeve. The inner cavity of the inner sleeve is provided with a push switch, a second battery, a wireless signal transmitting device and a return spring. The connecting sleeve includes an upper curved plate, a lower curved plate and an expansion joint that connects the upper curved plate and the lower curved plate. It has advantages of having a reasonable and simple structure, easy to use, safe and reliable, and high degree of intelligence, which effectively solves the problem of existing wheel locks being unable to ensure safety of vehicles.

### FIELD OF THE INVENTION

The invention relates to vehicle anti-theft devices, in particular, a disk intelligent rechargeable locking device for wheels based on cloud wireless control.

### BACKGROUND

Car owners usually need extra keys to lock vehicle wheels to prevent vehicles from being stolen. In the prior art, conventional locks for vehicle wheels are usually operated by keys. Once the keys are lost, it would be very troublesome. On the other hand, vehicle thieves can easily open these locks and steal the vehicles. In addition, the existing wheel locks usually have a large gap when being locked with the wheel. The vehicle thieves often use tools such as hydraulic shears, crowbars, screwdrivers, etc. to violently destroy the locks. The existing wheel locks are usually not connected to the vehicle frame. If the owner only locks the wheel, the vehicle thief may remove the wheel and steal the rest of the vehicle. Therefore, it is necessary to design a keyless locking device that is in a tight contact with the wheel and connects to a vehicle frame in a stable way.

### SUMMARY OF THE INVENTION

The technical problem to be solved is to overcome the above-mentioned deficiency by providing a disk intelligent rechargeable locking device for wheels based on cloud wireless control. It has advantages of having a reasonable and simple structure, easy to use, safe and reliable, and high degree of intelligence, which effectively solves the problem of existing wheel locks being unable to ensure safety of vehicles.

The technical solution of the invention is to provide a disk intelligent rechargeable locking device for wheels based on cloud wireless control which includes a first element, a second element, a connecting rod, and a connecting sleeve. The first element and the second element are symmetrically disposed on two sides of a wheel. The connecting sleeve and a frame are sleeved with each other. One end of the connecting rod is fixedly connected with the connecting sleeve, and the other end of the connecting rod is respectively fixedly connected to the first element and the second element.

The first element includes a first housing with a cylindrical structure, an end cap disposed on an opening of the first housing, a motor, a sleeve, a rotary encoder, a latch, a first battery, and a microcontroller integrated with a wireless transceiver. The motor, the rotary encoder, the first battery, and the microcontroller are fixedly disposed in the inner cavity of the first housing. The connecting rod is fixedly connected to the first housing.

The spindle of the motor is sequentially connected to the sleeve and the rotary encoder. The sleeve is circumferentially provided with a plurality of connecting shafts. The rotary encoder is used for detecting the angle of rotation of the motor, so as to control the rotation of the motor more precisely by the microcontroller. The wireless transceiver on the microcontroller is used to communicate with an external device and transmit a command (i.e lock or unlock) from the external device to the microcontroller.

The first housing is circumferentially disposed with a plurality of through holes. One end of the latch is slidably connected to the through hole, and the other end of the latch is hinged to the connecting shaft. The motor rotates to drive the connecting shaft, and the connecting shaft drives the latch to move upward and downward.

The second element includes an inner sleeve and an outer sleeve, wherein the inner sleeve and the outer sleeve each have a single opening and the opposite openings are sleeved with each other. The connecting rod is fixedly connected to the inner sleeve. The opposite openings are sleeved with each, which reduces the removable parts of the second element so as to prevent violent damage.

The inner cavity of inner sleeve is provided with a push switch, a second battery, a wireless signal transmitting device and a return spring. The inner cavity of outer sleeve is provided with a convex shaft extending to the inner cavity of inner sleeve. The opening of outer sleeve is circumferentially provided with a plurality of J-shaped slots for interconnecting with the latch. The outer sleeve is provided with a notch through which the connecting rod passes. The outer side of the inner sleeve is circumferentially provided with a plurality of curved chutes. The inner side of the outer sleeve is provided with a curved convex block adapted to the curved chute. The curved chute is slidably connected to the convex block. When the outer sleeve connects to the first element, once pulled by an external force, the connection can prevent the outer sleeve being torn off to break the lock.

The connecting sleeve includes an upper curved plate, a lower curved plate and an expansion joint for connecting the upper curved plate and the lower curved plate. The upper curved plate is provided with a first threaded hole. The lower curved plate is provided with a second threaded hole and a card slot.

The expansion joint is disposed in the first threaded hole, the second threaded hole, and the card slot. The expansion joint includes a rod member and a notched expansion sleeve sleeved on the rod member. The expansion sleeve is compressed and snapped into the card slot when the expansion joint is tightened. The two ends of the rod member are respectively provided with a first external thread and a second external thread which are adapted to the first threaded hole and the second threaded hole respectively. The expansion sleeve is compressed and expanded by the gradual tightening of the first external thread and the second external thread on the front end of the rod member, and finally is snapped in the card to prevent the rod member from being removed to disconnect the lock and the frame.

In a further embodiment, the microcontroller is electrically connected to the rotary encoder and the first battery respectively.

In a further embodiment, the end cap is provided with a battery charging port, and a waterproof rubber plug is disposed on the battery charging port.

In a further embodiment, the through hole is a stepped hole.

In a further embodiment, one end of the latch that is slidably connected to the through hole is provided with an L-shaped card plate for engaging the J-shaped slot. The height of the top end of the L-shaped card plate is lower than the height of the top end of the latch, When the push switch of the inner sleeve is pressed, the wireless signal transmitting device in the inner sleeve sends a signal to the microcontroller to control the motor to extend the latch to a certain height, so that the latch can be connected with the J-shaped slot. After the latch is connected with the J-shaped slot, the switch pops up. The wireless signal transmitting device in the inner sleeve sends a signal to the microcontroller to control the motor to continue to extend the latch to a certain height, so that the L-shaped card plate jams the outer sleeve, preventing the outer sleeve from getting out from the latch.

In a further embodiment, the push switch and the second battery are electrically connected to the wireless signal transmitting device.

In a further embodiment, the convex shaft and the outer sleeve are one-piece structure.

In a further embodiment, the connecting rod is made of a telescopic rod. The position of the first element and the second element can be adjusted according to different conditions of the specific vehicles, thereby increasing the applicability thereof.

In a further embodiment, the inner side of the upper curved plate and the lower curved plate are provided with a rubber pad to prevent the slidable displacement of the connecting sleeve.

In a further embodiment, one end of the expansion sleeve adjacent to the second threaded hole is fixedly connected to the rod member, and the expansion sleeve is compressed toward the fixed end to ensure that the expansion sleeve catches the rod member.

The technical effect of the invention is to provide a disk intelligent rechargeable locking device for wheels based on cloud wireless control. The first element and the second element are symmetrically disposed on two sides of a wheel. The first element and the second element are respectively connected to the frame via the connecting rod and the connecting sleeve. The

J-shaped slot on the outer sleeve is connected to the latch on the first element by rotating and passing through the wheel hub. The L-shaped card plate is disposed on the latch to catch the outer sleeve. The lock is tightly connected with the wheel, and the tools such as hydraulic shear and crowbars are difficult to operate on the lock and the wheel, which prevents violence damage to the lock. The lock and the frame are connected so that the vehicle cannot be stolen by removing the wheel. The latch and the L-shaped card plate are operated by the motor disposed on the first element. The microcontroller connects to an external device to control the operation of the motor without the need to use a key which avoids the lock being opened by someone who has skills to open a conventional lock. It has advantages of having a reasonable and simple structure, easy to use, safe and reliable, and high degree of intelligence, which effectively solves the problem of existing wheel locks being unable to ensure safety of vehicles.

### BRIEF DESCRIPTION OF THE DRAWINGS

The invention is illustrated by the following figures and embodiments.

FIG. 1 shows a schematic diagram of whole structure of a disk intelligent rechargeable locking device for wheels based on cloud wireless control in accordance with one embodiment.

FIG. 2 shows a schematic diagram of first element of a disk intelligent rechargeable locking device for wheels based on cloud wireless control in accordance with one embodiment.

FIG. 3 shows a schematic diagram of connection of a sleeve and a connecting shaft of a disk intelligent rechargeable locking device for wheels based on cloud wireless control in accordance with one embodiment.

FIG. 4 shows a schematic diagram of second element of a disk intelligent rechargeable locking device for wheels based on cloud wireless control in accordance with one embodiment.

FIG. 5 shows a schematic diagram of an inner sleeve of a disk intelligent rechargeable locking device for wheels based on cloud wireless control in accordance with one embodiment.

FIG. 6 shows a schematic diagram of an outer sleeve of a disk intelligent rechargeable locking device for wheels based on cloud wireless control in accordance with one embodiment.

FIG. 7 shows a schematic diagram of a connecting sleeve of a disk intelligent rechargeable locking device for wheels based on cloud wireless control in accordance with one embodiment.

FIG. 8 shows a schematic diagram of an expansion joint of a disk intelligent rechargeable locking device for wheels based on cloud wireless control in accordance with one embodiment.

The reference numbers of the figures are as follows:

1: first element; 10: first battery; 101: battery charging port; 102: waterproof rubber plug; 11: first housing; 111: through hole; 12: end cap; 13: motor; 14: sleeve; 15: connecting shaft; 16: latch; 17: L-shaped card plate; 18: rotary encoder; 19: microcontroller; 2: second element; 21: inner sleeve; 210: wireless signal transmitting device; 211: push switch; 212: second battery; 213: curved chute; 22: outer sleeve; 220: dent; 221: J-shaped slot; 222: convex shaft; 223: notch; 224: curved convex block; 23: return spring; 4: connecting rod; 40: connecting sleeve; 41: upper curved plate; 411: first threaded hole; 42: rubber pad; 43: lower curved plate; 431: card slot; 432: second threaded hole; 44: expansion joint; 441: second external thread; 442: rod member; 443: first external thread; 444: expansion sleeve; 445: diamond-shaped notch.

### DETAILED DESCRIPTION

The invention is illustrated in accordance with figures. The figures as simplified diagrams demonstrate the basic structures of the apparatus of embodiments of the invention. Thus, the invention is not limited to the figures.

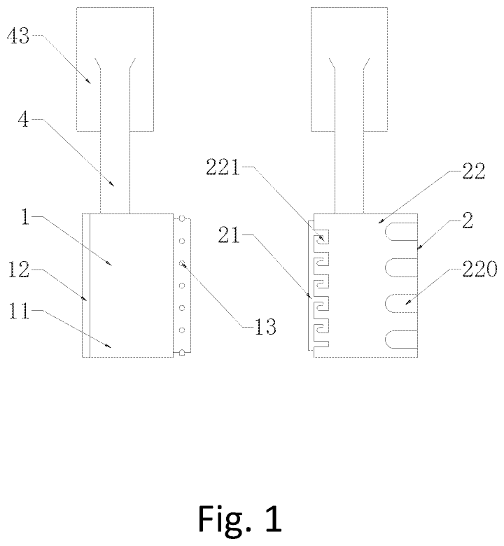

As show in FIG. 1, a disk intelligent rechargeable locking device for wheels based on cloud wireless control includes a first element 1, a second element 2, a connecting rod 4, and a connecting sleeve 40. The first element 1 and the second element 2 are symmetrically disposed on two sides of a wheel. The connecting sleeve 40 and a frame are sleeved with each other. One end of the connecting rod 4 is fixedly connected with the connecting sleeve 40, and the other end of the connecting rod 4 is respectively fixedly connected to the first element 1 and the second element 2. The first element 1 and the second element 2 connect to the frame via the connecting rod 4 and the connecting sleeve 40, respectively.

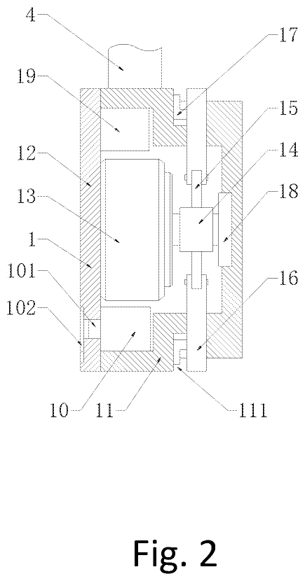

As shown in FIG. 2, the first element 1 includes a first housing 11 with a cylindrical structure, an end cap 12 disposed on an opening of the first housing 11, a motor 13, a sleeve 14, a rotary encoder 18, a latch 16, a first battery 10, and a microcontroller 19 integrated with a wireless transceiver. The motor 13, the rotary encoder 18, the first battery 10, and the microcontroller 19 are fixedly disposed in the inner cavity of the first housing 11. The connecting rod 4 is fixedly connected to the first housing 11.

The spindle of the motor 13 is sequentially connected to the sleeve 14 and the rotary encoder 18.

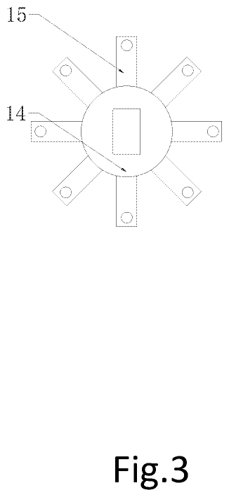

As shown in FIG. 3, the sleeve 14 is circumferentially provided with a plurality of connecting shafts 15. In an embodiment, the connecting shaft 15 and the sleeve 14 are one-piece structure. In another embodiment, the connecting shaft 15 is snapped or welded to the sleeve 14. In an embodiment, the sleeve 14 and the shaft of the motor 13 are one-piece structure.

As shown in FIG. 2, the first housing 11 is circumferentially disposed with a plurality of through holes 111. One end of the latch 16 is slidably connected to the through hole 111, and the other end of the latch 16 is hinged to the connecting shaft 15. The microcontroller 19 is electrically connected to the rotary encoder 18 and the first battery 10, respectively. The integrated wireless signal transmitting device of the microcontroller 19 is connected to an external device, receives an unlocking or locking command sent by the external device, and controls the rotation of the motor to drive the latch 16 to move up and down, thereby achieving the objectives of lock and unlock.

In an embodiment, the through hole 111 is a stepped hole. One end of the latch 16 that is slidably connected to the through hole 111 is provided with an L-shaped card plate 17 for engaging the outer sleeve 22. The height of the top end of the L-shaped card plate 17 is lower than the height of the top end of the latch 16.

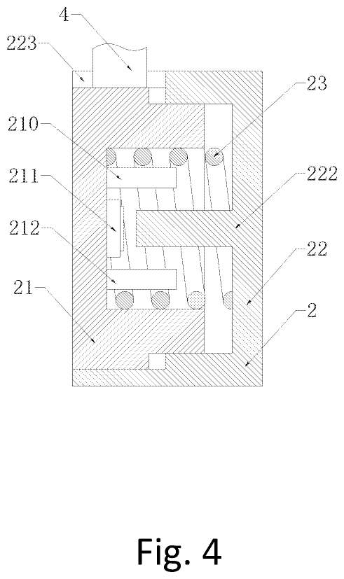

As shown in FIG. 4, the second element 2 includes an inner sleeve 21 and an outer sleeve22, wherein the inner sleeve 21 and the outer sleeve 22 each have a single opening and the opposite openings are sleeved with each other. The connecting rod 4 is fixedly connected to the inner sleeve 21. The opposite openings are sleeved with each, which reduces the removable parts of the second element so as to prevent violent damage.

The inner cavity of inner sleeve 21 is provided with a push switch 211, a second battery 212, a wireless signal transmitting device 210 and a return spring 23. The inner cavity of outer sleeve 22 is provided with a convex shaft 222 extending to the inner cavity of inner sleeve 21. The opening of outer sleeve 22 is circumferentially provided with a plurality of J-shaped slots 221 for interconnecting with the latch 16. The outer sleeve 22 is provided with a notch 223 through which the connecting rod 4 passes.

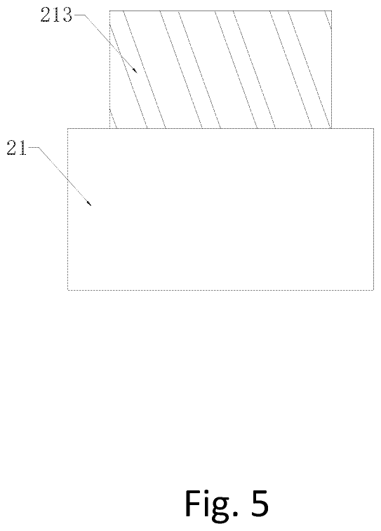

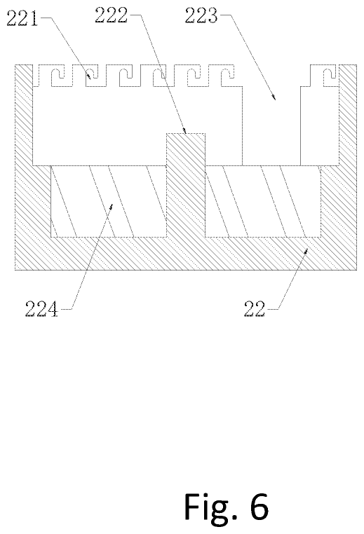

As shown in FIGS. 5 and 6, the outer side of the inner sleeve 21 is circumferentially provided with a plurality of curved chutes 213. The inner side of the outer sleeve 22 is provided with a curved convex block 224 adapted to the curved chute 213. The curved chute 213 is slidably connected to the convex block 224. The outer sleeve 22 is rotated to pass through the wheel hub. The wheel hub and the J-shaped slot 221 are engaged with each other. The J-shaped slot 221 and the latch 16 are connected to each other. The curved chute 213 is slidably connected to the curved convex block 224. This connection forms a certain resistance to prevent the outer sleeve 22 from being torn off, when the J-shaped slot 221 and the latch 16 are connected to each other, if there is an external force.

The push switch 211 and the second battery 212 are electrically connected to the wireless signal transmitting device 210, respectively. When the outer sleeve 22 rotates and moves toward the direction of the latch 16, the push switch 211 is pressed, and the wireless signal transmitting device 210 sends a signal to the microcontroller 19, and the latch 16 rises to a certain height. When the J-shaped slot 221 is connected to the latch 16, the push switch 211 is popped up under the action of the return spring 23, and the wireless signal transmitting device 210 sends a signal to the microcontroller 19. The latch 16 continues to rise to a certain height, and the L-shaped card plate 17 is extended to engage with the outer sleeve 22, to prevent the latch 16 from coming out of the J-shaped slot 221.

In an embodiment, the outer surface of the outer sleeve 22 is provided with a plurality of dents 220 for convenient gripping.

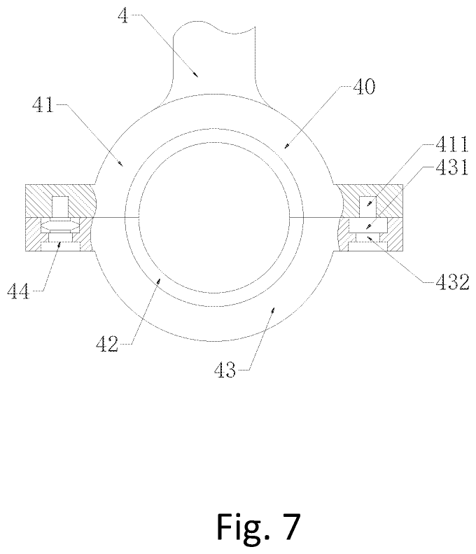

As shown in FIG. 7, the connecting sleeve 40 includes an upper curved plate 41, a lower curved plate 43 and an expansion joint 44 for connecting the upper curved plate 41 and the lower curved plate 43. The upper curved plate 41 is provided with a first threaded hole 411. The lower curved plate 43 is provided with a second threaded hole 432 and a card slot 431.

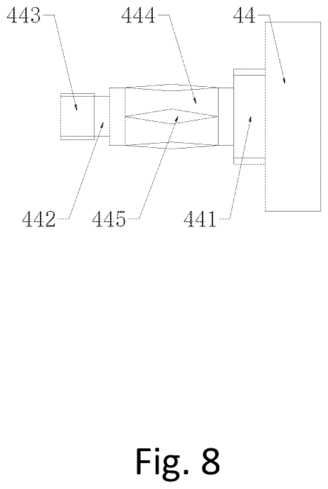

As shown in FIG. 8, the expansion joint 44 is disposed in the first threaded hole 411, the second threaded hole 432, and the card slot 431. The expansion joint 44 includes a rod member 442 and an expansion sleeve 444 with a diamond-shaped notch 445 sleeved on the rod member 442. The expansion sleeve 444 is compressed and snapped into the card slot 431 so that the rod member 442 is engaged to avoid violent damage to locks when the expansion joint is tightened. The two ends of the rod member 442 are respectively provided with a first external thread 443 and a second external thread 441 which are adapted to the first threaded hole 411 and the second threaded hole 432 respectively.

In an embodiment, the end cap 12 is provided with a battery charging port 101, and a waterproof rubber plug 102 is disposed on the battery charging port 101. In an embodiment, the battery charging port 101 can be used as a power outlet to charge an external device.

In an embodiment, the convex shaft 222 and the outer sleeve 22 are one-piece structure.

In an embodiment, the connecting rod is made of a telescopic rod.

In an embodiment, the inner side of the upper curved plate 41 and the lower curved plate 43 are provided with a rubber pad 42.

In an embodiment, one end of the expansion sleeve 444 adjacent to the second threaded hole 432 is fixedly connected to the rod member 442 to prevent the rod member 442 from getting out of the expansion sleeve 444.

A disk intelligent rechargeable locking device for wheels based on cloud wireless control of the invention includes a first element and a second element. The first element and the second element are symmetrically disposed on two sides of a wheel. The first element and the second element are respectively connected to the frame via the connecting rod and the connecting sleeve. The J-shaped slot on the outer sleeve is connected to the latch on the first element by rotating and passing through the wheel hub. The L-shaped card plate is disposed on the latch to catch the outer sleeve. The lock is tightly connected with the wheel, and the tools such as hydraulic shear and crowbars are difficult to operate on the lock and the wheel, which prevents violence damage to the lock. The lock and the frame are connected so that the vehicle cannot be stolen by removing the wheel. The latch and the L-shaped card plate are operated by the motor disposed on the first element. The microcontroller connects to an external device to control the operation of the motor without the need to use a key which avoids the lock being opened by someone who has skills to open a conventional lock. It has advantages of having a reasonable and simple structure, easy to use, safe and reliable, and high degree of intelligence, which effectively solves the problem of existing wheel locks being unable to ensure safety of vehicles.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A disk intelligent rechargeable locking device for wheels based on cloud wireless control, comprising: a first element 1, a second element 2, a connecting rod 4, and a connecting sleeve 40;
wherein the first element 1 and the second element 2 are symmetrically disposed on two sides of a wheel; the connecting sleeve 40 and a frame are sleeved with each other; one end of the connecting rod 4 is fixedly connected with the connecting sleeve 40, and the other end of the connecting rod 4 is respectively fixedly connected to the first element 1 and the second element 2,
wherein the first element 1 includes a first housing 11 with a cylindrical structure, an end cap 12 disposed on an opening of the first housing 11, a motor 13, a sleeve 14, a rotary encoder 18, a latch 16, a first battery 10, and a microcontroller 19 integrated with a wireless transceiver; the motor 13, the rotary encoder 18, the first battery 10, and the microcontroller 19 are fixedly disposed in the inner cavity of the first housing 11; the connecting rod 4 is fixedly connected to the first housing 11,
wherein the spindle of the motor 13 is sequentially connected to the sleeve 14 and the rotary encoder 18; the sleeve 14 is circumferentially provided with a plurality of connecting shafts 15,
wherein the first housing 11 is circumferentially disposed with a plurality of through holes 111; one end of the latch 16 is slidably connected to the through hole 111, and the other end of the latch 16 is hinged to the connecting shaft 15,
wherein the second element 2 includes an inner sleeve 21 and an outer sleeve22; the inner sleeve 21 and the outer sleeve 22 each have a single opening and the opposite openings are sleeved with each other; the connecting rod 4 is fixedly connected to the inner sleeve 21,
wherein the inner cavity of inner sleeve 21 is provided with a push switch 211, a second battery 212, a wireless signal transmitting device 210 and a return spring 23; the inner cavity of outer sleeve 22 is provided with a convex shaft 222 extending to the inner cavity of inner sleeve 21; the opening of outer sleeve 22 is circumferentially provided with a plurality of J-shaped slots 221 for interconnecting with the latch 16; the outer sleeve 22 is provided with a notch 223 through which the connecting rod 4 passes; the outer side of the inner sleeve 21 is circumferentially provided with a plurality of curved chutes 213; the inner side of the outer sleeve 22 is provided with a curved convex block 224 adapted to the curved chute 213,
wherein the connecting sleeve 40 includes an upper curved plate 41, a lower curved plate 43 and an expansion joint 44 for connecting the upper curved plate 41 and the lower curved plate 43; the upper curved plate 41 is provided with a first threaded hole 411; the lower curved plate 43 is provided with a second threaded hole 432 and a card slot 431,
wherein the expansion joint 44 is disposed in the first threaded hole 411, the second threaded hole 432, and the card slot 431; the expansion joint 44 includes a rod member 442 and an expansion sleeve 444 with a diamond-shaped notch 445 sleeved on the rod member 442; the expansion sleeve 444 is compressed and snapped into the card slot 431; the two ends of the rod member 442 are respectively provided with a first external thread 443 and a second external thread 441 which are adapted to the first threaded hole 411 and the second threaded hole 432 respectively.

2. The disk intelligent rechargeable locking device for wheels based on cloud wireless control of claim 1, wherein the microcontroller 19 is electrically connected to the rotary encoder 18 and the first battery 10, respectively.

3. The disk intelligent rechargeable locking device for wheels based on cloud wireless control of claim 1, wherein the end cap 12 is provided with a battery charging port 101, and a waterproof rubber plug 102 is disposed on the battery charging port 101.

4. The disk intelligent rechargeable locking device for wheels based on cloud wireless control of claim 1, wherein the through hole 111 is a stepped hole.

5. The disk intelligent rechargeable locking device for wheels based on cloud wireless control of claim 1, wherein one end of the latch 16 that is slidably connected to the through hole 111 is provided with an L-shaped card plate 17 for engaging the outer sleeve 22; the height of the top end of the L-shaped card plate 17 is lower than the height of the top end of the latch 16.

6. The disk intelligent rechargeable locking device for wheels based on cloud wireless control of claim 1, wherein the push switch 211 and the second battery 212 are electrically connected to the wireless signal transmitting device 210, respectively.

7. The disk intelligent rechargeable locking device for wheels based on cloud wireless control of claim 1, wherein the convex shaft 222 and the outer sleeve 22 are one-piece structure.

8. The disk intelligent rechargeable locking device for wheels based on cloud wireless control of claim 1, wherein the connecting rod is made of a telescopic rod.

9. The disk intelligent rechargeable locking device for wheels based on cloud wireless control of claim 1, wherein the inner side of the upper curved plate 41 and the lower curved plate 43 are provided with a rubber pad 42.

10. The disk intelligent rechargeable locking device for wheels based on cloud wireless control of claim 1, wherein one end of the expansion sleeve 444 adjacent to the second threaded hole 432 is fixedly connected to the rod member 442.
